(19) United States
(12) Patent Application Publication
(10) Pub. No.: US 2022/0215314 A1
(43) Pub. Date: Jul. 7, 2022

(54) Systems and Methods for Improved Management of the Supply Chain in a Construction Project

(71) Applicant: Hyphen Solutions, LLC, Dallas, TX (US)

(72) Inventors: Christopher F. Sugg, Grapevine, TX (US); Manuel G. Gomez, JR., McKinney, TX (US); Felix Vasquez, JR., Westlake, TX (US)

(21) Appl. No.: 17/143,803

(22) Filed: Jan. 7, 2021

(51) Int. Cl. G06Q 10/06; G06Q 50/08; H04W 4/029

(52) U.S. Cl. CPC G06Q 10/06316; H04W 4/029; G06Q 10/063114; G06Q 50/08

(57) ABSTRACT

The present disclosure is directed to management of the supply chain in the construction field, and includes generating a workflow comprising a plurality of ordered tasks relating to a construction project, wherein each task of the plurality of ordered tasks is associated with a provider of a plurality of providers and is further associated with one or more status identifiers indicating a status of each task; receiving a real-time status update related to a given task of the plurality of ordered tasks, the given task associated with a given provider of the plurality of providers, wherein the real-time status update is associated with status information input by the given provider via a provider interface of a provider platform; updating a status identifier associated with the given task based on the received real-time status update; and generating an updated workflow for display on provider devices associated with the plurality of providers.

### TECHNICAL FIELD

The present disclosure generally relates to the field of construction, and more specifically to systems and methods for improved management of the supply chain in a construction project.

### BACKGROUND

In the construction industry, multiple entities are involved in coordinating the building of a structure for an end customer. In residential construction, the supply chain may be relatively large, as a home builder may utilize the products and services of numerous third parties, including suppliers, manufacturers, distributors, contractors, and other parties who supply the materials and products and/or perform the labor necessary to construct a home for a home buyer.

### BRIEF DESCRIPTION OF THE DRAWINGS

FIG. 1 illustrates a system for managing the supply chain in a construction project, in accordance with certain embodiments;

FIG. 2 illustrates an example display screen showing a comprehensive customized workflow associated with a construction project, in accordance with certain embodiments;

FIG. 3 illustrates an example display screen showing a scheduling and dispatching feature for use in a construction project, in accordance with certain embodiments; and

FIG. 4 illustrates an example display screen of a field device showing a configurable list of action items for use by a field worker of a provider, in accordance with certain embodiments;

FIG. 5 illustrates an example display screen of a provider device showing a tracking feature for use by a back office of a provider, in accordance with certain embodiments;

FIG. 6 illustrates a flow diagram of a method for managing the supply chain in a construction project, in accordance with certain embodiments; and

FIG. 7 illustrates a computer system, in accordance with certain embodiments.

### DESCRIPTION OF EXAMPLE EMBODIMENTS

### Overview

According to an embodiment, a system may include one or more processors and one or more computer-readable non-transitory storage media comprising instructions that, when executed by the one or more processors, cause one or more components of the system to perform operations including, generating a workflow comprising a plurality of ordered tasks relating to a construction project associated with a construction site, wherein each task of the plurality of ordered tasks is associated with a provider of a plurality of providers and is further associated with one or more status identifiers indicating a status of each task; receiving a real-time status update related to a given task of the plurality of ordered tasks, the given task associated with a given provider of the plurality of providers, wherein the real-time status update is associated with status information input by the given provider via a provider interface of a provider platform; updating at least one status identifier associated with the given task based on the received real-time status update to create an updated workflow; and generating the updated workflow for display on a plurality of provider devices associated with the plurality of providers.

Moreover, the workflow may be generated based on a plurality of task codes.

Additionally, the received real-time status update may include information associated with a field worker of the given provider. The received real-time status update may be associated with a geolocation of a field worker, and may indicate that the field worker has arrived on the construction site to perform the given task. In an embodiment, the received real-time status update may indicate that the field worker has completed performance of the given task at the construction site.

In an embodiment, the real-time status update may automatically trigger an alert to a next given provider associated with a next given task of the plurality of ordered tasks that the next given task is impending performance.

Furthermore, the operations may include automatically assigning a field worker of the given provider to perform the given task based on parameters relating to at least one of the field worker, the given task, or the construction project.

According to another embodiment, a method may include the steps of generating a workflow comprising a plurality of ordered tasks relating to a construction project associated with a construction site, wherein each task of the plurality of ordered tasks is associated with a provider of a plurality of providers and is further associated with one or more status identifiers indicating a status of each task; receiving a real-time status update related to a given task of the plurality of ordered tasks, the given task associated with a given provider of the plurality of providers, wherein the real-time status update is associated with status information input by the given provider via a provider interface of a provider platform; updating at least one status identifier associated with the given task based on the received real-time status update to create an updated workflow; and generating the updated workflow for display on a plurality of provider devices associated with the plurality of providers.

According to yet another embodiment, one or more computer-readable non-transitory storage media may embody instructions that, when executed by a processor, cause the performance of operations, including generating a workflow comprising a plurality of ordered tasks relating to a construction project associated with a construction site, wherein each task of the plurality of ordered tasks is associated with a provider of a plurality of providers and is further associated with one or more status identifiers indicating a status of each task; receiving a real-time status update related to a given task of the plurality of ordered tasks, the given task associated with a given provider of the plurality of providers, wherein the real-time status update is associated with status information input by the given provider via a provider interface of a provider platform; updating at least one status identifier associated with the given task based on the received real-time status update to create an updated workflow; and generating the updated workflow for display on a plurality of provider devices associated with the plurality of providers.

Technical advantages of certain embodiments of this disclosure may include one or more of the following. The systems and methods described herein may allow for the integration and coordination of the entire supply chain of a residential construction project. The system may allow for the collective input and transmission of data across a builder platform having a builder interface and a provider platform having one or more provider interfaces, so that builders and providers (including suppliers, contractors, distributors, wholesalers, manufacturers, and the like) may perform tasks, maintain current information, and manage the status of the construction project from start to finish.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

In the field of residential construction, a builder designs and then builds a home according to a set of parameters determined by a homeowner. Parameters may include, for example, budget, location, type of home (e.g., traditional, modern, etc.), grade of home (e.g., basic, mid-level, luxury), square footage, and other features. To execute the building of the home, the builder may involve and manage contractors, sub-contractors, suppliers, vendors, distributors, manufacturers, labor trades, and various other entities (individually and collectively referred to in this disclosure as “providers”). Each provider may be responsible for a different phase of the construction process. For example, one provider may be contracted to grade and prepare the lot; another provider may be responsible for laying the foundation; still other providers may be responsible for framing, roofing, sheetrock, plumbing, electricals, flooring, and more. Further, each of these tasks may require additional providers to supply the necessary materials (e.g., wood for framing, carpet or tiles for flooring, shingles for roofing, etc.) Additionally, each successive task may build on a previous one. For example, roofing and sheetrock cannot commence until framing is completed. Framing cannot commence until the foundation is laid, and so on. Thus, the supply chain for a residential construction project requires much management and coordination on the part of the builder to ensure that each stage of the construction process is completed correctly and on time before the next stage can commence.

Conventionally, the management of the supply chain for a residential construction project requires the builder to separately contact, communicate with, instruct, and manage each provider manually. For example, the builder is often forced to travel to the construction site to confirm that the correct materials have been delivered on time, and that a given provider has arrived on site as scheduled to begin work on a particular phase of the project. Additional trips to the construction site may be required to confirm that the work is progressing on schedule, has been completed, and/or is ready for inspection. For a typical construction project having over one hundred tasks and a corresponding number of providers performing the work, this can be quite cumbersome. Moreover, for a builder having to manage this process for dozens or hundreds of homes, a system is needed to ensure that the hundreds of tasks are properly managed, coordinated, and executed.

The present disclosure is directed to systems and methods that allow for the integration and coordination of the plurality of tasks, information, and management activities associated with a residential construction project. Specifically, the present disclosure provides a builder platform having a builder interface for use by a builder, and a provider platform having a one or more provider interfaces for use by one or more providers. Each of the platforms, i.e., the builder platform having the builder interface and the provider platform having the one or more provider interfaces, may include functionality that is specific to the business and services of a particular entity, so that the given entity may use its respective platform for the management of its own business, while at the same time integrating certain functionality and management tools across platforms, so that for a given construction project or plurality of construction projects (e.g., such as in a subdivision, or a plurality of subdivisions), the builder and providers may collectively input data, share information, communicate updates, and otherwise cooperatively manage the construction project(s) from start to finish.

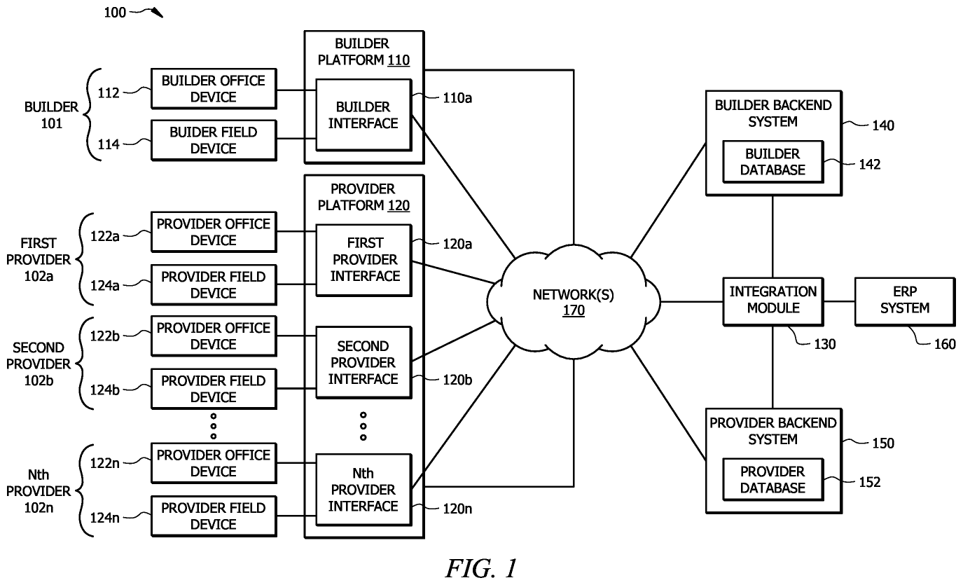

FIG. 1 depicts a system 100 for improved management of a supply chain in a residential construction project. The system 100 may include a builder platform 110 having at least one builder interface 110a. The builder interface 110a may be the means by which a builder 101 may access the builder platform 110 via a builder office device 112 and/or a builder field device 114. The system 100 may further include a provider platform 120 having one or more provider interfaces (e.g., a first provider interface 120a, a second provider interface 120b, and a N^{th} provider interface 120n are shown in FIG. 1, wherein the “N^{th}” or “n” designation indicates that any number of provider interfaces may be included in system 100). The first, second, and N^{th} provider interfaces 120a-n are the means by which first, second and N^{th} providers 102a-n may access the provider platform 120 via provider office devices (e.g., 122a, 122b, 122n) and provider field devices (e.g., 124a, 124b, 124n). For example, a first provider 102a may access the provider platform 120 through the first provider interface 120a using the first provider's office device 122a and/or field device 124a. Similarly, a second provider 102b may access the provider platform 120 through the second provider interface 120b using the second provider's office device 122b and/or field device 124b, and so on. For purposes of the present disclosure, the first, second, and N^{th} provider interfaces (120a, 120b, 120n) are associated with first, second, and N^{th} providers (102a, 102b, 102n) working with the builder 101 in conjunction with a construction project. In other words, FIG. 1 is intended to illustrate system 100 as it relates to a single builder 101 and its associated providers 102a-n in conjunction with a particular construction project. However, it is to be understood that system 100 may accommodate any number of builders having any number of associated providers for any number of construction projects, the system operable to correlate builders and providers based on the construction project, as described below. The system 100 may further include an integration module 130, a builder backend system 140, a provider backend system 150, and an enterprise resource planning (ERP) system 160. All of the foregoing components of system 100 may be communicatively connected through a network 170. Each of these components will be described in turn.

The builder platform 110 may be a software platform configured for use by builders. The builder platform 110 may include a builder interface 110a associated with a particular builder 101 that enables the builder 101 to access the builder platform 110. The builder 101 (or employees of the builder 101) may access the builder platform 110 through the builder interface 110a using a builder office device 112 or a builder field device 114 through, e.g., a website, mobile application, or other Internet-based tool. While FIG. 1 shows one builder office device 112 and one builder field device 114 for accessing the builder platform 110 through the builder interface 110a, it is to be understood that for a given construction project, the builder 101 may have multiple builder office devices and multiple builder field devices configured to access the builder platform 110 through the builder interface 110a. The builder office device 112 and the builder field device 114 may each comprise any appropriate device for sending and receiving communications over the network 170. By way of example and not by way of limitation, builder office device 112 and/or builder field device 114 may comprise a wireless or cellular telephone, a laptop computer, a desktop computer, a tablet, or any other wired or wireless device capable of accessing the network 170 and receiving, processing, storing, and/or communicating information with other components of system 100. The builder platform 110 may include functionality to schedule and manage a construction project, including the plurality of providers associated with the construction project, as further described below. While FIG. 1 shows a single builder interface 110a configured for a single builder 101, it is to be understood that the builder platform 110 of system 100 may comprise any number of builder interfaces for use by any number of builders, with each builder interface configured and/or customized to the specifications of the associated builder.

The provider platform 120 may be a software platform configured for use by one or more providers (102a-n) through one or more provider interfaces (120a-n), with each provider 102a-n accessing the provider platform 120 through its respective provider interface, e.g., a first provider 102a accessing the provider platform 120 through the first provider interface 120a, a second provider 102b accessing the provider platform 120 through the second provider interface 120b, etc. For simplicity, the functionality of the provider platform 120 and provider interfaces 120a-n will be described in conjunction with the first provider 102a. By way of example, a first provider 102a (or employees of the first provider 102a) may access the provider platform 120 through the first provider interface 120a using a provider office device 122a and/or a provider field device 124 through, for example, a website, mobile application, or other Internet-based tool. While FIG. 1 shows one provider office device 122a and one provider field device 124a associated with the first provider interface 120a, it is be understood that a first provider 102a may have a plurality of provider office devices and a plurality of provider field devices configured to access the provider platform 120 through the first provider interface 120a. The provider office device 122a and the provider field device 124a may each be any appropriate device for sending and receiving communications over the network 170. By way of example and not by way of limitation, provider office device 122a and provider field device 124a may each comprise a wireless or cellular telephone, a laptop computer, a desktop computer, a tablet, or any other wired or wireless device capable of accessing the network 170 and receiving, processing, storing, and/or communicating information with other components of system 100. Additionally, since providers in the residential construction context may include one or more suppliers, contractors, sub-contractors, manufacturers, wholesalers, labor trades, and/or distributors, for a given construction project, system 100 may include a plurality of provider interfaces 120a-n for accessing the provider platform 120 by a plurality of providers 102a-n. Each provider 102a-n may customize its provider interface 120a-n based on its specific business and the services it provides.

The builder backend system 140 may comprise a computer system which may be accessed by a system administrator of a builder 101 and may include, among other things, at least one builder database 142 for storing data associated with a builder 101. While FIG. 1 shows the builder backend system 140 as having one builder database 142, it is to be understood that the builder backend system 140 may include a plurality of builder databases associated with a plurality of builders, construction projects, etc. The builder database 142 may comprise a memory, processing circuitry, one or more interfaces, and/or other components known in the art. The memory may be used to store information communicated to the builder database 142. For example, the memory may store workflow templates, task codes, and other data used by the system 100 to effectively set up and manage a construction project. Processing circuitry may process information, data, and/or instructions input into the builder database 142 relating to the construction project. The one or more interfaces may be configured to allow communication and transmission of data between the builder database 142 and the integration module 130 and/or the builder platform 110. Additionally, the builder backend system 140 may also be used by the system administrator to onboard a builder 101 onto the builder platform 110.

The provider backend system 150 may comprise a computer system which may be accessed by systems administrators of one or more providers 102a-n and may include, among other things, at least one provider database 152 for storing data associated with at least one provider 102a. While FIG. 1 shows the provider backend system 150 as having one provider database 152, it is to be understood that the provider backend system 150 may include a plurality of provider databases associated with a plurality of providers 102a-n, construction projects, etc. The provider database 152 may comprise a memory, processing circuitry, one or more interfaces, and/or other components known in the art. The memory may be used to store information communicated to the builder database 152. For example, the memory may store provider data used by the system 100 to effectively set up and manage a construction project. Processing circuitry may process the information input into the provider database 152 relating to the construction project. One or more interfaces may be configured to allow communication and transmission of data between the provider database 152 and the integration module 130 and/or the provider platform 120. Additionally, the provider backend system 150 may be used by the system administrator to onboard a provider 102a or a plurality of providers 102a-n onto the provider platform 120.

The integration module 130 may be configured to coordinate and transmit information to, from, and between the builder platform 110 and the provider platform 120. In an embodiment, the integration module 130 may serve as the conduit for the flow of data between the builder platform 110 and the provider platform 120, i.e., data that is input by a builder 101 through a builder office device 112 or builder field device 114 into the builder interface 110a of the builder platform 110 may be processed by and transmitted through the integration module 130 to the provider platform 120 and thereafter accessed by a provider (e.g., 102a) through a provider interface (e.g., 120a) via a provider office device (e.g., 122a) and/or provider field device (e.g., 124a), or through a plurality of provider interfaces 120a-n via a plurality of provider office devices 122a-n and a plurality of provider field devices 124a-n. Likewise, data that is input by a provider 102a through a provider office device 122a or a provider field device 124a into the provider interface 120a of the provider platform 120 may be processed by and transmitted through the integration module 130 to the builder platform 110 and thereafter accessed by the builder 101 through the builder platform 110 via a builder office device 112 and/or a builder field device 114. The integration module 130 may provide a direct connection between the builder platform 110 and the provider platform 120, as well as the databases of the builder backend system 140 and the provider backend system 150. In an embodiment, the integration module 130 may comprise an application programming interface (API). Additionally, as described above, the integration module 130 may include components of a computer system, such as a processor and a memory, as further shown and described in conjunction with FIG. 7.

The ERP system 160 may be used by a builder to input task codes associated with a construction project. While FIG. 1 depicts ERP system 160 as a separate component communicably coupled to the integration module 130, it is to be understood that the ERP system 160 may be configured in any manner. For example, in an embodiment, the ERP system 160 may be part of the builder platform 110. In another embodiment, the ERP system 160 may comprise a third party system separate from the builder platform 110.

The network 170 may include one or more wired networks, one or more wireless networks, or a combination of wired and wireless networks. The builder platform 110, the provider platform 120, the integration module 130, the builder backend system 140, and the provider backend system 150 may communicate with each other via network 170.

By way of a general overview, the disclosed system 100 may be used to manage one or more residential construction projects. Specifically, for a given construction project, the system 100 may be configured to generate a comprehensive workflow for use by a builder 101 and a plurality of providers 102a-n. The comprehensive workflow may comprise a plurality of ordered tasks relating to the construction project. Each task of the plurality of ordered tasks may be associated with or assigned to a given provider, and may include one or more status identifiers indicating status(es) of the task. The workflow may be accessed by the builder 101 through the builder interface 110a of the builder platform 110 (and displayed on a builder office device 112 and/or a builder field device 114), and may be further accessed by the plurality of providers 102a-n through their respective provider interfaces 120a-n in the provider platform 120 (and displayed on provider office devices 122a-n and/or provider field devices 124a-n). Each provider may input status information relating to its associated or assigned task(s), and the system 100 then transmit or share that information to the builder platform 110 and the provider platform 120, so that the builder 101 and the plurality of providers 102a-n associated with the construction project may view the updated status information in real-time. For example, a first provider 102a may input status information relating to its assigned task into the provider platform 120 through the first provider interface 120a via a provider office device 122a (e.g., by back office employees of the first provider 102a) and/or through a provider field device 124a (e.g., by field workers of the first provider 102a). The status information input into the provider platform 120 through the first provider interface 120a may be transmitted to the provider database 152 of the provider backend system 150, and then to the integration module 130, which processes the status information and transmits the corresponding status update (in real-time) to the builder platform 110 and/or the provider platform 120. The builder 101 and/or the plurality of providers 102a-n may then instantly view the status update on their associated devices 112, 114, 122a-n, 124a-n. In this manner, and as described in detailed below, the builder 101 and the plurality of providers 102a-n associated with the construction project may maintain current, real-time information regarding the statuses of tasks associated with the construction project.

With continued reference to FIG. 1, the detailed operation of the system 100 will now be described. First, a builder 101 may be onboarded to system 100. During a builder onboarding process, wherein a builder is onboarded to a builder platform 110 of the system 100, the builder 101 may be assigned a builder identification number (builder ID) that is stored in the system 100, and particularly, in the integration module 130 and/or the builder backend system 140. In an embodiment, the system 100 may authenticate and/or recognize the builder 101, as well as permit certain actions by the builder 101 in the builder platform 110, based on this builder ID. Once the system 100 has associated the builder 101 with its a builder ID, the builder 101 may provide or input into an ERP system 160 a plurality of task codes associated with the construction project. In another embodiment, the plurality of task codes may be auto-generated by the system 100 based on, for example, the type of home associated with the construction project. For purposes of the present disclosure, a “construction project” may refer to the building of a residential home. If the builder is building a plurality of residential homes, e.g., in a subdivision or a plurality of subdivisions, there may be a plurality of construction projects, each construction project having a set of task codes. In one embodiment, each of the plurality of construction projects may have the same set of task codes (e.g., where the homes are substantially the same in terms of type, grade, features, etc.). In another embodiment, each of the plurality of construction projects may have a different set of task codes (e.g., where the homes are different in terms of type, grade, features, etc.). In still other embodiments, some of the construction projects may have the same set of task codes, and other construction projects may have different sets of task codes. For purposes of illustration and to simplify the description, the system 100 will be described in terms of a single construction project having a plurality of task codes.

Each task code input by the builder 101 into the ERP system 160 (or auto-generated by the system 100) may comprise an alphanumeric/numeric code (typically referred to in the construction industry as a “cost code”) corresponding to a task in the construction project. Task codes are generally associated with a purchase order or a work order. Moreover, each task code may correspond to a task that is billable and typically results in the generation of an invoice when the task is completed. There may be dozens or hundreds of tasks codes input by the builder into the ERP system 160, corresponding to dozens or hundreds of tasks associated with the construction project, from start to finish. By way of example, pre-construction tasks may include surveying, rough grading, sewer system preparation, running utility connections, and the like. Tasks may also include the delivery of materials, such as pipes for utilities, wood for framing, shingles for roofing, sheetrock, flooring, cabinetry, countertops, appliances for installation, etc.

In an embodiment, the builder 101, a system administrator and/or an implementation member may input the task codes associated with the construction project into the ERP system 160. In another embodiment, the plurality of task codes may be auto-generated by the system and transmitted to the integration module. The integration module 130 may receive these inputs, from the ERP system 160 or otherwise, and may correlate each task code with a task or a plurality of tasks provided in a master task template, which may be stored in database of the integration module 130. The master task template may include hundreds of tasks, i.e., every conceivable task on a residential construction project. Thus, for a given construction project, the integration module 130 may auto-correlate the task codes received from the ERP system 160 with relevant and corresponding tasks stored in the master template. Since every task listed in the master template will not be applicable for every construction project, the auto-correlation process essentially selects all tasks applicable to the construction project at hand, and removes all inapplicable tasks. By way of example, if the construction project relates to the construction of a one-story home, the integration module 130 may determine that tasks associated with a staircase or a second-story structure would be inapplicable and therefore would not select these tasks in the master template. In an embodiment, there may not be a one-to-one correlation between the task codes received from the ERP system 160 and the tasks selected in the master template. By way of example, the integration module 130 may determine that a given task code corresponds to a plurality of tasks in the master template. Once all of the task codes input into the ERP system 160 are correlated to appropriate tasks in the master task template, the integration module 130 outputs to the builder platform 110 and the provider platform 120 a comprehensive customized workflow (or a customized job schedule) associated with the construction project. The comprehensive customized workflow includes every task to be completed in conjunction with the construction project.

The comprehensive customized workflow may also include the providers that are associated with or assigned to the plurality of tasks. Specifically, the integration module 130 may correlate the providers 102a-n to their associated task(s) as follows. During the builder onboarding process (or at any point subsequent thereto), the builder 101 may input or designate in the ERP system 160 providers 102a-n selected for the construction project. If a given provider (e.g., 102a) that has been selected by the builder 101 has already onboarded into the system 100, the provider 102a may have an associated provider identification number (provider ID) stored in the integration module 130 and/or in the provider backend system 150. If a given provider (e.g., 102b) has not previously onboarded into the system 100, the provider 102b may be onboarded and may be assigned a provider ID. For a given construction project, the integration module 130 receives from the ERP system 160 the list of selected providers input by the builder 101, correlates the providers 102a-n with their corresponding provider IDs, and further correlates the provider IDs with the builder ID of the builder 101 that has selected the providers. The integration module 130 further links the builder ID of the builder 101 and the provider IDs of the designated list of providers 102a-n with a provider platform identification number (provider platform ID) specific to the construction project, thereby a creating a fixed three-way link between itself, the builder 101, the providers 102a-n, and the respective platforms through which the parties will be sharing data. As a result, information/data may flow between the builder platform 110 and the provider platform 120 when updates are made on either side by any of the parties (builder 101 and/or any of the plurality of providers 102a-n). Once the integration module 130 correlates the task codes received from the ERP system 160 with the tasks stored in the master task template in the integration module 130, correlates each task with the appropriate provider, and further creates the three-way link described above, the integration module 130 may then push out to the builder platform 110 and the provider platform 120 the comprehensive workflow and/or set of tasks required for the construction project. As a result, the builder platform 110 and the provider platform 120 may “generate” (i.e., by using the information provided by the integration module 130) the comprehensive workflow comprising a plurality of ordered tasks for use by the builder 101 and the plurality of providers 102a-n. Then, when the builder 101 logs into its builder platform 110 through the builder interface 110a via the builder office device 112 and/or the builder field device 114, and/or when any of the providers 102a-n logs into the provider platform 120 through their respective provider interface 120a-n via a provider office device 122a-n and/or a provider field device 124a-n, each entity may have access to the comprehensive customized workflow and related information associated with the construction project. Each entity (i.e., the builder 101 and/or each of the providers 102a-n) may be able to communicate with one or more other entities, input and receive data relating to statuses of tasks, and otherwise manage relevant aspects of the construction project. In an embodiment, the builder field device 114 and/or the provider field device 124a-n may only be able to access certain information associated with the construction project, e.g. specific tasks of the comprehensive customized workflow which may assigned to a builder field worker or a provider field worker associated with the builder field device 114 or the provider field device 124a-n, respectively, as determined by a system administrator.

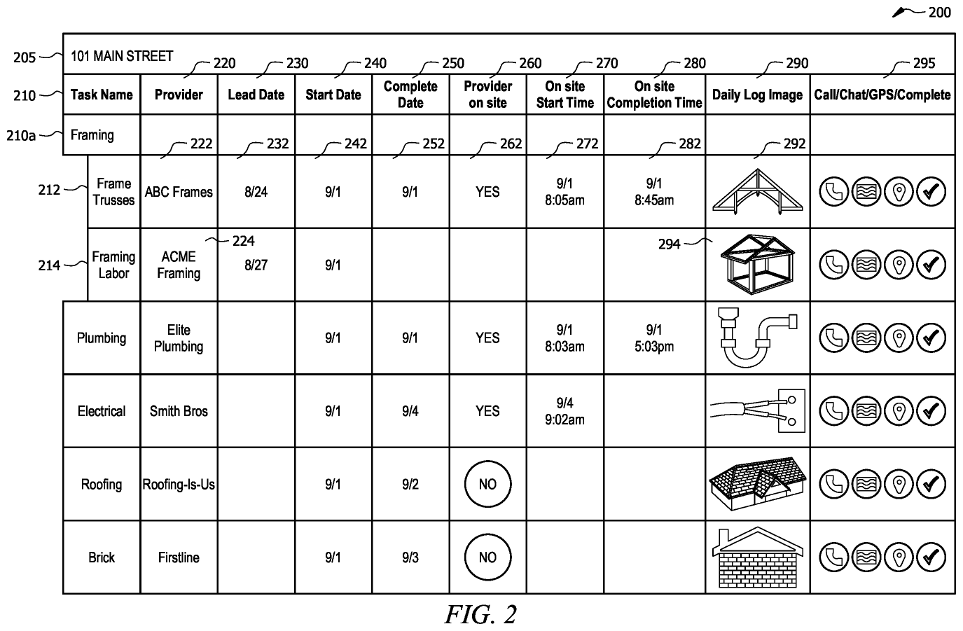

Reference is now made to FIG. 2, in conjunction with FIG. 1. Similar and corresponding terms described in conjunction with FIG. 1 may be used to describe the functionality shown in FIG. 2. FIG. 2 shows an example screenshot of a comprehensive customized workflow 200 associated with a construction project. The comprehensive customized workflow 200 may be made available to the builder 101 through the builder interface 110a of the builder platform 110 and displayed on a builder office device 112 and/or a builder field device 114. A similar workflow (not shown) may be available for providers 102a-n through the provider interfaces 120a-n of the provider platform 120 and displayed on provider office devices 122a-n and/or provider field devices 124a-n, as applicable. It is to be understood that the comprehensive customized workflow 200 of FIG. 2 may be modified based on the party accessing the comprehensive customized workflow 200, e.g., different features, elements, and functionalities may be contemplated, as appropriate, for the builder 101 versus the plurality of providers 102a-n. It is further to be understood that FIG. 2 sets forth a small segment of the comprehensive customized workflow 200, detailing only a handful of the hundreds of tasks that would typically be included in conjunction with a construction project.

As described above, the builder platform 110 and the provider platform 120 may be configured as customizable software-based platforms that are accessible to the builder 101 and the plurality of providers 102a-n through an application, a website, or other network-based functionality on the builder office device 112, the builder field device 114, the provider office devices 122a-n, and the provider field devices 124a-n, respectively. By way of example, when a builder 101 accesses the builder platform 110 through the builder interface 110a on a builder office device 112, e.g., using a login and password, the builder 101 may be presented with functionality to manage one or more construction projects. For each construction project, the builder may view on the builder office device 112 the comprehensive customized workflow 200 generated by the system 100. In an embodiment, because the builder 101 may manage a plurality of construction projects, the system 100 may generate and display on the builder office device 112 a plurality of comprehensive, customized workflows for the plurality of construction projects, each identified by subdivision, home address, and/or the like.

Similarly, when a provider, e.g., the first provider 102a, enters and accesses the provider platform 120 through a provider interface, e.g., the first provider interface 120a, on a provider office device 122a, the first provider 102a may be presented with functionality to manage the first provider's 102a tasks associated with one or more construction projects. For each construction project, the first provider 102a may view on the provider office device 122a a comprehensive customized workflow generated by the system. In an embodiment, because the first provider 102a may be responsible for tasks on a plurality of construction projects, the system may generate and display on the provider office device 122 a plurality of comprehensive workflows associated with the plurality of construction projects, each identified by subdivision, home address, and/or the like. Thus, although not shown in FIGS. 1-2, the system of the present disclosure allows first provider 102a to manage multiple construction projects at a given time. The specific functionality and features made available in the workflow to the first provider 102a through a provider office device 122a may differ from that made available to a builder 101 through a builder office device 112. For example, while the builder 101 may desire to know the on-site status of the plurality of providers 102a-n, the first provider 102a may not need to know the on-site status of each of the plurality of other providers 102b-n. Likewise, the first provider 102a may not need to contact or communicate with the plurality of other providers 102b-n. Therefore, the workflow 200 and the functionality made available thereon may be customized so that the builder 101 and the plurality of providers 102a-n may be able to access information and use functionality relevant to them.

In the example of FIG. 2, the comprehensive customized workflow 200 for the construction project may be viewed by street address 205 (e.g., 101 Main Street). The workflow 200 may comprise a listing of a plurality of ordered tasks 210 (shown in FIG. 2 under the heading, “Task Name”) and may include tasks such as framing, plumbing, electrical, roofing, brick, etc. The plurality of ordered tasks may be listed in chronological order, alphabetical order, or according to any other method of organization. In an embodiment, the plurality of ordered tasks may be listed according to a general task name, and may include a sub-listing of specific tasks. For example, the general task of “Framing” 210a may be selected to reveal a sub-listing of tasks that includes “Frame Trusses” 212 and “Framing Labor” 214. In an embodiment, each of the plurality of ordered tasks 210 may be associated with a task code provided by the builder 101 and input into the ERP system 160, and processed and auto-correlated by the integration module 130. In another embodiment, the plurality of ordered tasks 210 may further include “reminders” that are not associated with task codes input by the builder 101, but are auto-generated by the system in connection with a particular task. For example, reminders may comprise actions that are non-invoiceable that the builder 101 and/or a provider 102a-n is responsible for (e.g., measurements, scheduling an inspection, etc.)

Further, the each of the plurality of ordered tasks 210 may be associated with a provider 220 assigned to complete the task 210. By way of example, the ordered sub-tasks relating to the frame trusses task 212 and the framing labor task 214, may each be associated with a provider name, e.g., ABC Frames 222 and ACME Framing 224. (For purposes of illustration ABC Frames 222 may correspond to the first provider 102a of FIG. 1, and ACME Framing 224 may correspond to the second provider 102b of FIG. 1.) For each of these ordered tasks 212, 214, the builder 101 may communicate with the associated provider through the builder interface 110a of the builder platform 110 on a builder office device 112 and/or a builder field device 114. For example, for the Frame Trusses task 212, the builder 101 may send and receive notifications, e-mails, and other communications relating to the task 212 by, e.g., selecting the provider name (ABC Frames 222) and/or task 212 associated with the first provider 102a to open up a communication window for transmitting data to the provider 102a.

Each task of the plurality of ordered tasks 210 may further be associated with one or more status identifiers 230, 240, 250, 260, 270, 280, 290 comprising information indicating the status of the task. By way of example, FIG. 2 shows the following status identifiers: “Lead Date” status identifier 230 (the date scheduled to contact the provider regarding preparation for the task), “Start Date” status identifier 240 (the date the provider is scheduled to start the task), “Complete Date” status identifier 250 (the date the provider is scheduled to complete the task), “Provider on Site” status identifier 260 (whether geolocation data indicates the provider or a field worker associated with the provider is on the construction site to perform the task), “On-Site Start Time” status identifier 270 (the time the provider or a field worker associated with the provider began work on a given day), “On-Site Completion Time” status identifier 280 (the time the provider or a field worker associated with the provider ended/completed work on the task), and “Daily Log Image” status identifier 290 (an image captured by the provider in relation to the task). It is to be understood that status identifiers 230, 240, 250, 260, 270, 280, 290 are shown for purposes of example only, and the present disclosure is not to be limited to the specific status identifiers described herein.

The “Provider on Site” status identifier 260, “On-Site Start Time” status identifier 270, “On-Site Completion Time” status identifier 280, and “Daily Log Image” status identifier 290 may be updated based on status information input by a field worker of a provider 102a-n via a field device 124a-n through a provider interface 120a-n on the provider platform 120. Additionally, certain status identifiers, e.g., “Provider on Site” 260, “On-Site Start Time” 270, and “On-Site Completion Time” 280, may be associated with a geolocation feature available on a provider field device 124a-n.

The one or more status identifiers 230, 240, 250, 260, 270, 280, 290 may be updated on the builder platform 110 and the provider platform 120 in response to status information input via devices in system 100, e.g., input by a provider 102a-n via a provider interface 120a-n through a provider office device 122a-n or a provider field device 124a-n, or input by the builder 101 via a builder interface 110a through a builder office device 112 or a builder field device 114. In other words, whenever status information is input into a device 112, 114, 122a-n, 124a-n, via a builder interface 110a or a provider interface 120a-n, the corresponding status identifier (230, 240, 250, 260, 270, 280, 290) may be updated on the builder platform 110 and the provider platform 120, and may be displayed through the builder interface 110a and the plurality of provider interfaces on all applicable devices 112, 114, 122a-n, 124a-n.

Specifically, when a provider (for example, the first provider 102a corresponding to ABC Frames 222 listed on the workflow 200) enters or inputs status information relating to its associated task (e.g., task 212, referred to generally as the “first task”) into the provider platform 120 through the first provider interface 120a, that status information is transmitted to and stored in the provider database 152 of the provider backend system 150. The provider backend system 150 then forwards the information to the integration module 130. The integration module 130 may process the status information input by the first provider into the provider platform 120, including by determining the appropriate one or more status identifiers 232, 242, 252, 262, 272, 282, 292 that must be updated in response to the status information input by the first provider 102a, and may push the corresponding status update(s) relating to the first task 212 to the builder platform 110 and the provider platform 120 in real-time. The builder platform 110 and the provider platform 120 may receive the real-time status update(s) associated with the status of the first task 212 and update the appropriate one or more status identifier(s) 232, 242, 252, 262, 272, 282, 292 based on the information received from the integration module 130, thereby creating an updated workflow. The updated customized workflow having the one or more updated status identifier(s) 232, 242, 252, 262, 272, 282, 292 may be generated by builder platform 110 and the provider platform 120 for displaying on builder devices 112, 114, and the plurality of provider devices 122a-n, 124a-n in real-time, thereby allowing the entire supply chain associated with the construction project to view the real-time status of the construction project at any given time.

In an embodiment, a builder 101 may also enter and/or update status information through a builder interface 110a of the builder platform 110. By way of example, when the builder 101 enters or inputs status information relating to a task into the builder platform 110 through the builder interface 110a, as applicable, that status information is transmitted to and stored in the builder database 142 of the builder backend system 140, which then forwards the information to the integration module 130. The integration module 130 may process the status information input by the builder (including by determining the appropriate one or more status identifiers 230, 240, 250, 260, 270, 280, 290 that must be updated in response to the status information input by the builder) and may push the corresponding status update(s) relating to the task to the builder platform 110 and the provider platform 120 in real-time. The builder platform 110 and the provider platform 120 may receive the real-time status update(s) associated with the status(es) of the task and update the appropriate one or more status identifier(s) 230, 240, 250, 260, 270, 280, 290 based on the information received from the integration module 130, thereby creating an updated workflow. The updated workflow having the one or more updated status identifier(s) 230, 240, 250, 260, 270, 280, 290 may be generated by builder platform 110 and the provider platform 120 for displaying on builder devices 112, 114, and the plurality of provider devices 122a-n, 124a-n in real-time.

In certain embodiments, it may not be desirable for information input by the builder 101 or a provider 102a to be transmitted and/or visible to all of the parties of the supply chain. For example, certain information may be intended only for a particular provider. For purposes of illustrating this embodiment, a “Lead Date” status identifier 230 which, when updated, may be relevant only to a particular provider, may be updated as follows. When the builder 101 (or employee of the builder 101) logs into the builder platform 110 through the builder interface 110a on a builder office device 112, he may view the comprehensive customized workflow 200 for a construction project and see an alert associated with the “Lead Date” status identifier 232 related to a “Frame Trusses” task 212. The “Lead Date” status identifier 232, listing a lead date of “08/24”, may be displayed in red outline, may include an exclamation mark, or may include some other designation indicating an alert. The alert may be generated by the system 100 to indicate that the associated task is impending, e.g., here, that the frame trusses used for framing will soon need to be delivered. In an embodiment, the lead date listed on the “Lead Date” status identifier 232 may be auto-generated by the system 100 based on the anticipated schedule of the construction project. In another embodiment, this lead date may be input by the builder 101 through the builder interface 110a on the builder platform 110 via a builder office device 112. In response to the alert associated with the “Lead Date” status identifier 232, the builder 101 may select the “Frame Trusses” task 212 and/or “Lead Date” status identifier 232 on the comprehensive customized workflow through the builder office device 112 to send a notification to the associated provider (here, the first provider 102a corresponding to “ABC Frames” 222) that the “Frame Trusses” task 212 (referring to the delivery of frame trusses for framing the home) will be required by an indicated date. In an embodiment, the indicated date may correspond to the scheduled start date as listed on “Start Date” status identifier 242. The notification may be transmitted to and stored in the builder database 142 of the builder backend system 140, which then forwards the information to the integration module 130, which may then process the information and push the notification to the provider platform 120, such that only the first provider 102a may view the notification. The first provider 102a may receive the notification on a provider office device 122a. The first provider 102a may view the order (including the purchase order and any other documentation related to the task), and may choose to accept the task. If the first provider 102a accepts the task, a reverse process may ensue, wherein a notification/status information of the first provider 102a is then transmitted to the builder 101. Specifically, the first provider 102a may select “Accept” on a provider office device 122a and may further indicate whether the materials will be delivered by the indicated start date (here, “09/01”), or by some other alternate date. Each of these inputs relating to status information associated with the “Frame Trusses” task 212 may be made by the first provider 102a on a provider office device 122a, received by the provider database 152 in the provider backend system 150, and then transmitted to the integration module 130. The integration module 130 may process the status information input by the first provider 102a (i.e., the “Accept” notification by the first provider 102a and the date the provider 102a will provide the materials for framing) and push a corresponding status update to the builder platform 110 and the provider platform 120 in real-time. The builder platform 110 and the provider platform 120, upon receiving the real-time status updates, may update the “Lead Date” status identifier 232 associated with the “Frame Trusses” task 212 (e.g., by removing the alert on the “Lead Date” status identifier 232, and by inserting in the “Start Date” status identifier 242 the date the provider has confirmed the framing materials will be delivered). Thus, the “Lead Date” status identifier 232 and the “Start Date” status identifier 242 may be updated in both the builder platform 110 and the provider platform 120, and may be viewed in real-time by the builder 101 and the first provider 102a (as well as the other plurality of providers 102b-n, as applicable). Thus, in this manner, the system may allow for back and forth communication between a builder 101 and a provider 102a (as well as the plurality of providers 102a-n) and the real-time update of status(es) associated with a construction project without the need for in-person meetings, on-site confirmations, etc.

With continued reference to FIG. 2 and further to the illustration described above, the completion of a task (e.g., the first task 212) by a first provider 102a, as indicated by a status update (i.e., an update to a status identifier 230, 240, 250, 260, 270, 280, 290), may trigger an automatic notification or alert to inform or alert the other providers 102b-n that the first task is complete, which may further alert the next provider in the supply chain that its task is due, impending, etc. For example, when a field worker of the first provider 102a, ABC Frames 222, arrives at the construction site on the indicated start date to deliver the frame trusses, he may deliver the order and then indicate that delivery is compete through a provider field device 124a (e.g., by touch selection of a “Complete Order” or similar icon on a screen, or by entering information on a keypad on the field device, or other action indicating completion of delivery). This status information relating to the “Frame Trusses” task 212 input by the field worker on the provider field device 124a may be received at the provider database 152 of the provider backend system 150, and then transmitted to and processed by the integration module 130, which then pushes the information to the builder platform 110 and the provider platform 120. The builder platform 110 and the provider platform 120 may receive the real-time status update relating to the “Frame Trusses” task 212 (namely, that the task has been completed by the field worker of the provider 102a) and may update one or more status identifiers associated therewith. For example, the “On Site Completion Time” status identifier 282, indicating the date and time the task was completed, may be updated, thereby resulting in an updated workflow 200. The updated workflow 200 may then be displayed through the builder interface 110a on the builder office device 112 and/or the builder field device 114, and through the provider interfaces 120a-n on the plurality of provider office devices 122a-n and/or provider field devices 124a-n. In an embodiment, the real-time status updates displayed by the builder platform 110 and the provider platform 120 may also alert the next scheduled provider, e.g., ACME Framing 224, who may depend on the delivery of the frame trusses to commence its task of framing, that the frame trusses have indeed been delivered.

In an embodiment, the system 100 may be configured to automatically notify the next scheduled provider of an upcoming task for which it is responsible. For example, as described above, the plurality of ordered tasks 210 of the comprehensive customized workflow 200 may be chronologically listed. When a given task has progressed to a threshold level (e.g., the task has been accepted by a provider, the task has commenced, and/or the task is close to completion), as indicated by one or more status identifiers 230, 240, 250, 260, 270, 280, the system 100 may automatically transmit a notification or alert to the next scheduled provider in the supply chain associated with the next given task that its task is impending performance. For example, in accordance with an example described above, if the first provider 102a, ABC Frames 222, associated with the “Frame Trusses” task 212 has confirmed its start date, i.e., the date the framing trusses are to be delivered (as indicated by the “Start Date” status identifier 242), the system 100 may automatically alert or notify the second provider 102b, ACME Framing 224, that its framing labor services will be required on or about that date. In this manner, the system 100 may be used to ensure that the construction project stays on schedule, and that successive providers 102a-n who depend on the completion of certain tasks in order to commence their own tasks, can confirm the status of those certain tasks, thereby collectively ensuring that the construction project progresses on schedule.

In an embodiment, field devices 124a-n associated with field workers of providers 102a-n may further include functionality to capture an image of a task, whether it is completed or in progress. For example, where a task is associated with the delivery of supplies (such as the “Frame Trusses” task 212 illustrated above), a field worker may capture an image of the delivered frame trusses with his provider field device 124a. The image, also constituting status information provided by the field worker, may be transmitted to and stored in the provider database 152 of the provider backend system 150, which then forwards the information to the integration module 130. The integration module 130 may process the status information (here, an image) and push the image to the builder platform 110 and the provider platform 120. The image may appear as a “Daily Log Image” status identifier 292 in the workflow 200. This imaging feature may be particularly useful for providers who deliver products such as countertops, appliances, flooring, and other products that are required to be delivered unblemished to the construction site. Thus, the field worker may indicate not only completion of delivery through his field device 124a (shown as an update to the “On-Site Completion Time” status identifier 282), but may also capture an image of the delivered product (shown as an update to the “Daily Log Image” status identifier 292 on the workflow 200). The imaging feature may also be used by field workers to capture images of tasks associated with the structure itself. For example, for a task is associated with framing (such as the “Framing Labor” task 214), a field worker may capture an image at the end of each work day to show the progress of the framing task. Each day's image may be uploaded through the provider platform 120 to the provider database 152 of the backend provider system 150, transmitted to and processed by the integration module 130, transmitted to the builder platform and the provider platform 120, and displayed as a “Daily Log Image” status identifier 294, as described above. The builder 101 and the plurality of providers 102a-n may view the captured image on their respective builder and provider devices 112, 114, 122a-n, 124a-n through their respective builder interface 110a and provider interfaces 120a-n. In an embodiment, the builder 101 may receive a notification on the builder office device 112 regarding the updated “Daily Log Image” status identifier 294. The builder 101 may then view the image and approve the work (by appropriate push notification on the builder device 112 through the builder platform 110), and the system may issue an invoice to the builder 101 for the completed task. In an embodiment, the issuance of an invoice may be automatically performed by the system 100 once a particular task (e.g., a threshold task) is completed (e.g., approval of delivery or work by the builder, etc.)

In an embodiment, the real-time status update may comprise information associated with a field worker. For example, a provider field device 124a-n may include a geolocation feature which may be used by a field worker associated with a provider 102a-n to indicate his arrival on the construction site associated with the construction project to perform an assigned task. For example, a particular field worker associated with a second provider 102b (i.e., ACME Framing 224) may be assigned to the “Framing Labor” task 214 (e.g., construction of the framing for the construction project). The field worker may be assigned to the task 214 by the second provider 102b, or may be auto-assigned to the task 214 by the system 100 based on the credentials and availability of the field worker as stored in the system 100, as described in an embodiment below. In either case, the system 100 may store in the provider backend system 150 a user ID of field worker, and may further correlate that user ID with the specific task(s) assigned to the field worker (here, the “Framing Labor” task 214). When the field worker arrives on site to begin work on the task 214, the field worker may select an option (e.g., by touch selection on a screen or by entering information on a keypad) on his provider field device 124b to indicate that he has arrived on the construction site. This status information may be input by the field worker on his provider field device 124b, and then transmitted to and stored in the provider database 152 of the provider backend system 150, forwarded to and processed by the integration module 130, and pushed out by the integration module 130 as a status update to the builder platform 110 and the provider platform 120. In an embodiment, the integration module 130 may correlate the user ID of the field worker, the task (e.g., “Framing Labor” task 214) assigned to the field worker, the location of the construction project in which the task is to be performed, and the geolocation of the field worker, to confirm that the field worker is indeed onsite. If all of these elements match, the system will confirm that the field worker is onsite for the correct task and thereby update the appropriate status identifier(s) to indicate that the field worker of the second provider 102b (ACME Framing 224) has arrived onsite to perform the “Framing Labor” task 214. Specifically, the Provider On Site” 260 status identifier may be updated in response to the use of the geolocation feature by the field worker. Other status identifiers may also be associated with the geolocation of the field worker, as applicable, including, “On Site Start Time” 270 status identifier (updated when the field worker indicates that he has begun work for that day on the construction site), and/or “On Site Completion Time” 280 status identifier (updated when the field worker indicates that he has completed the task on the construction site). The foregoing status identifiers may include date and time metrics.

While the builder 101 and the plurality of providers 102a-n may access and share data relevant to the workflow 200 of the construction project, each entity's interface may be customized specifically for its own business. For example, the builder interface 110a may provide a builder 101 with a global view and management functionality with respect to the construction project. The builder interface 110a may have the capability to communicate with, transmit data to, and receive data from each of the plurality of providers 102a-n associated with the construction project. The builder interface 110a may further have functionality to enable it to propose/submit orders, pay invoices, and perform other actions that may be specific to the builder 101. In contrast, provider interfaces 120a-n may have different functionality with respect to the construction project. In an embodiment, the provider interfaces 120a-n may only enable providers to communicate with the builder 101 and/or certain other providers. For example, the provider interface 120a of the first provider 102a that supplies frame trusses may enable communication with the second provider 102b performing the framing, but not with the provider delivering or installing appliances. Additionally, different types of providers may have different functionality on their respective provider interfaces 120a-n. For example, the provider interface 120a associated with the first provider 102a who is supplying frame trusses or wood for framing may include functionality to confirm delivery of the frame trusses or wood, while the provider interface 120b associated with the second provider 102b who is performing the labor of framing may include functionality to confirm completion of framing, as well as to capture and transmit images showing the completed framing. The functionality available through a builder interface 110a and/or a plurality of provider interfaces 120a-n may be customized based on requirements of a given builder, a given provider, and/or a given construction project. In an embodiment, the plurality of provider interfaces 120a-n may allow providers 102a-n to input data, information, and images relating to statuses of their work, and may further allow providers 102a-n to view the comprehensive customized workflow 200 and associated statuses of other providers in the construction project, and thereby maintain real-time knowledge of the activities of the supply chain.

Turning specifically now to the provider interfaces 120a-n and the functionality offered therein, for a given construction project, a given provider, e.g., first provider 102a, may communicate with the builder 101 through the first provider interface 120a on the provider platform 120 via an associated provider office device 122a and/or a provider field device 124a. Through the provider office device 122a and/or the provider field device 124a, the first provider 102a may receive notifications, e-mails, and other communications from the builder 101 relating to one or more tasks associated with the construction project. Similarly, through the provider office device 122a and/or the provider field device 124a, the first provider 102a may transmit notifications, e-mails, and other communications to the builder 101 relating to one or more of its assigned tasks associated with the construction project, including by accepting/confirming upcoming tasks, confirming completion of a task, and the like. Through a provider field device 124a, a field worker associated with the first provider 102a may transmit information relating to the construction project. For example, as described above, the field worker may confirm his arrival at the construction site associated with the construction project, may alert the builder 101 of the start time and/or completion time of the work associated with an assigned task, and may capture and upload images relating to the assigned task.

While the comprehensive customized workflow 200 of FIG. 2 has been described above in connection with two tasks, i.e., the “Frame Trusses” task 212 and the “Framing Labor” task 214, associated with a first provider 102a and a second provider 102b (i.e., “ABC Frames” 222 and “ACME Framing” 224, respectively), it is to be understood that these are shown for purposes of illustration only. The present disclosure contemplates a workflow having dozens or hundreds of tasks associated with dozens or hundreds of providers. Additionally, the system 100, the comprehensive customized workflow 200, and the functionality described in conjunction therewith is not to be limited to the specific features described. Additional or different elements, functionality, and/or operations (including the number, type, and functions associated with status identifiers) may be contemplated without departing from the scope of the present invention. For example, the comprehensive customized workflow 200 may include additional functionality 295 that may be accessed and used by a builder 101 and/or providers 102a-n through a builder interface 110a and/or provider interfaces 120a-n, respectively. Such functionality 295 may include a phone feature (for calling the builder or a provider), a chat feature (for electronic chatting), a GPS feature (for determining a geolocation of a field worker), and a “Task Complete” feature (for selection by the builder to indicate that the task has been completed).

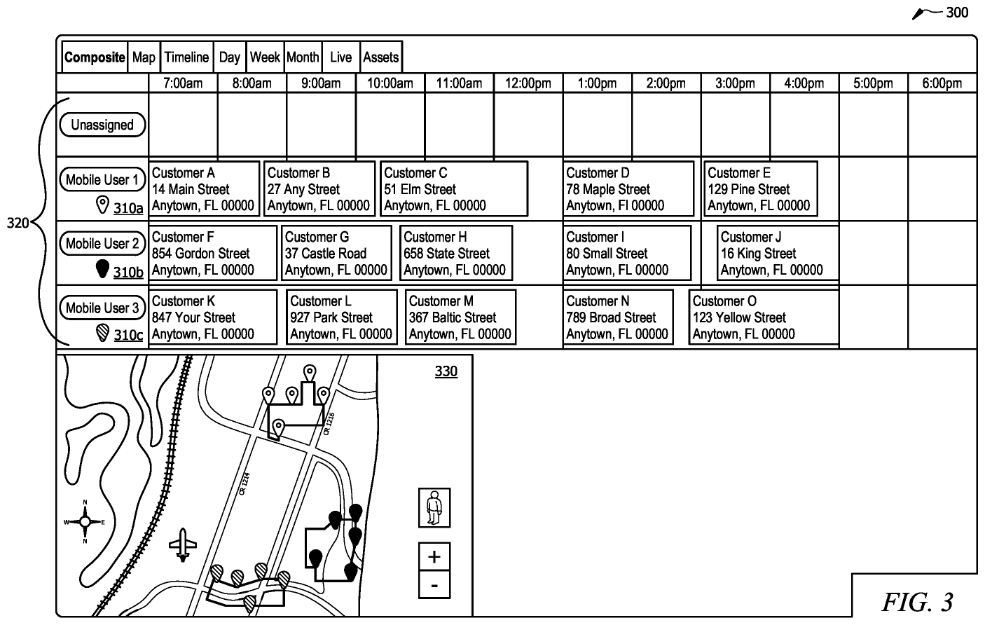

Reference is now made to FIG. 3, wherein is shown an example display screen demonstrating a scheduling and dispatching feature 300 available to a provider 102a-n, as displayed on a provider office device 122a-n through a provider interface 120a-n and as generated through the provider platform 120. Similar and corresponding terms used to describe system 100 in conjunction with FIG. 1 may be used to describe the functionality shown in FIG. 3. In accordance with the present disclosure, a provider 102a-n may schedule a plurality of field workers 310a, 310b, 310c based on job type, skill, certification, training, and/or any other parameters. Field workers 310a, 310b, 310c may be scheduled out over a period of seven days, thirty days, or any number of days, as determined by the provider 102a-n. The provider 102a-n may view, on its provider office device 122a-n, a schedule 320 of each field worker 310a, 310b, 310c, as well as an interactive map 330 that shows where each field worker 310a, 310b, 310c is scheduled on a given day. If the provider desires to amend a particular field worker's 310a schedule (for example, if an emergency task requires the immediate attention of a field worker on an unscheduled construction project), the provider 102a-n may use the interactive map 330 to determine which field worker(s) are closest in proximity to the emergency site. The provider may then dispatch the appropriate field worker. In another embodiment, the scheduling and dispatching feature 300 may be used to determine which field worker 310a, 310b, 310c is scheduled to be closest to a prospective job site at a future point in time (e.g., in seven days). In yet another embodiment, the provider platform 120a may provide automated assignment and dispatching functionality, wherein the system 100 may automatically assign and dispatch a field worker to perform a task at a construction site for a construction project based on one or more parameters relating to the field worker, the task, and/or the construction project. For example, parameters may include the proximity of the field worker to a construction site, the availability of the field worker on the desired day/time the task is to be completed at the construction site, the training, certification, credentials, or skillset of the field worker as it pertains to the task to be completed at the construction site, the requirements associated with the task and/or construction project, and/or any other parameters known or considered in the art relating to the assignment of a field worker to a construction-related task. In an embodiment, the system 100 may correlate one or more parameters associated with a field worker (e.g., the worker's training, certification, credentials, skillset, location, and/or availability) which may be stored in the system (e.g., in a provider database 152) with the requirements of a given task of the construction project (e.g., the task to be completed, the geographic location of the task, the date/time the task is to be completed, the skills required for the task, etc.), and then match the correct field worker with the given task. In another embodiment, the scheduling and dispatching feature 300 may be used for route optimization of field workers to minimize overall distance traveled in a given day and/or increase the number of jobs that may be performed in a given day. Metrics relating to distance traveled, duration on the job site, etc. may be compiled by the system 100 to generate reports for use by the provider 102a-n.

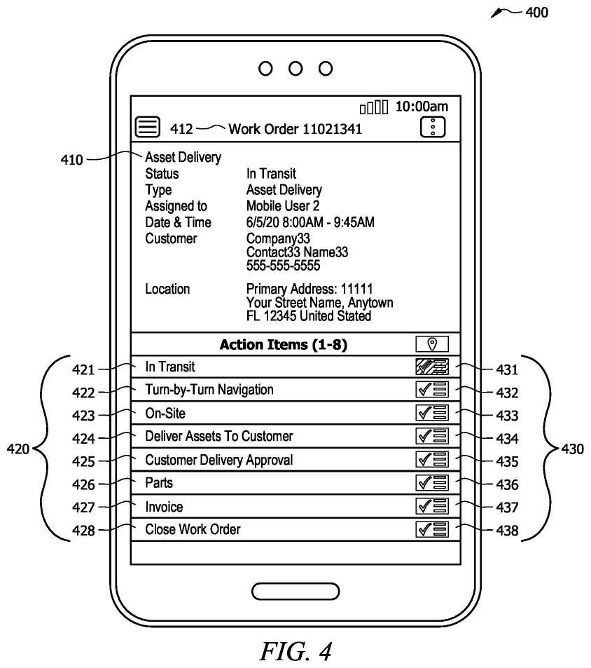

Various other features may be available for use by a provider 102a-n through provider interfaces 120a-n on the provider platform 120. Reference is now made to FIG. 4, wherein is shown an example display screen 400, as generated through the provider platform 120, of a provider field device 124a-n associated with a field worker of a provider 102a-n. Similar and corresponding terms used to describe system 100 in conjunction with FIG. 1 may be used to describe the functionality shown in FIG. 4. As shown in FIG. 4, the provider field device 124a may include various features that are beneficial to a builder 101 as well as a provider 102a-n, who may be managing field workers from a back office. For example, once a field worker logs in to the provider platform through a provider interface 120a-n, the provider field device 124a may display a configurable list of action items 420 associated with a task 410 assigned to the field worker. For purposes of illustration, the task 410 displayed in FIG. 4 is associated with a specific Work Order 412. When the field worker assigned to the task 410 pulls up the associated Work Order 412 on his field device 124a, a plurality of actions items 420 may be displayed. The list of action items 420 may be listed in chronological order, and the field device 124a-n may display a set of completion markers 430 that may be utilized by the field worker to “check off” each action item as it is completed. In an embodiment, the completion markers 430 may turn from red to green (or some other indicator) to indicate that their corresponding action items have been completed. The plurality of actions items 420 may be sequenced (i.e., listed in the order they are to be completed), and may generated and populated by the system 100 and/or may be customized by the provider. In an embodiment, each successive action item of the plurality of action items 420 may not be “checked off” until the previous action item has been “checked off” Thus, the completion marker 437 for the “Invoice” action item 427 and the completion marker 438 for the “Close Work Order” action item 428 may only be checked off when the previous action items 421-426 have been completed, as indicated by selection of their corresponding completion markers 431-436. Once the completion marker 437 for the “Invoice” action item 427 is checked, the system 100 may automatically generate an invoice for transmission to the builder 101. Specifically, the invoice may be generated through the provider platform 120, which then transmits the invoice to the provider database 152 of the provider backend system 150, which then pushes the invoice to the integration module 130. The integration module 130 may then transmit the invoice to the builder platform 110, so that it may be made available for viewing and payment by the builder 101 through a builder office device 112.

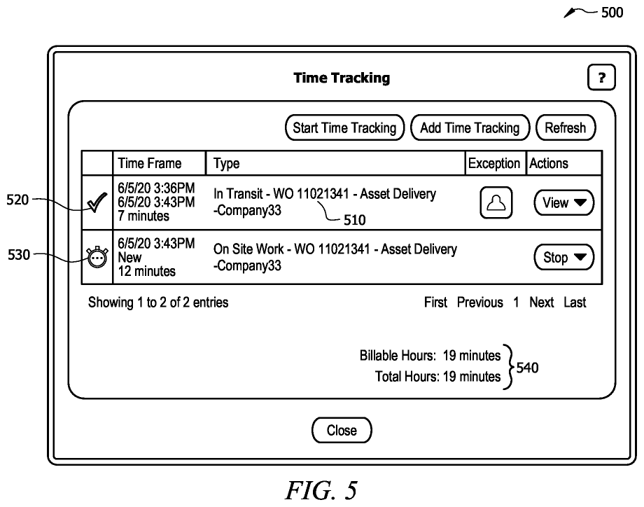

In an embodiment, multiple actions may be triggered by “checking off” a completion marker 430 for an action item 420. For example, when the field worker selects the completion marker 431 for the “In Transit” action item 421, the system 100 may update the status of the task 410 in the provider platform 120 and/or the builder platform 110 (this may include updates to status identifiers in the workflow 200, as described above in conjunction with FIG. 2). In addition to updating the workflow 200, the system 100 may also send one or more notifications to the builder 101 and/or the particular provider 102a-n (e.g., first provider 102a) associated with the field worker that the field worker is on the way. The system 100 may further enable the first provider 102a associated with the field worker to track the transit time of the field worker, as described below in conjunction with FIG. 5. Specifically, the provider field device 124a may include a geolocation feature. As shown in FIG. 4, when the field worker gets into his vehicle to travel to the job site, he may indicate that he is “In Transit” 421 by “checking off” the corresponding completion marker 431. A notification may be sent to a provider office device 122a in the provider's back office, letting the first provider 102a know that the field worker in “In Transit”, as well as the start time of his transit. Next, the field worker may select the completion marker 432 for the “Turn by Turn Navigation” action item 421 to bring up a navigation feature on the provider field device 124a. The field worker may use the navigation feature to navigate to the construction site. The system's 100 geolocation feature may further allow the provider to track the route of the field worker. When the field worker arrives to the construction site, the field worker may select the completion maker 433 for the “On-Site” action item 423, and a notification may be sent to the provider office device 122a in the first provider's back office that the field worker has arrived “On-Site”, as well as his time of arrival. In an embodiment, the geolocation feature may be activated using Global Position Satellite (GPS) technology, and may not require the field worker to select a completion maker 430 to trigger the geolocation feature.

Reference is now made to FIG. 5, wherein is shown an example display screen 500, as generated through the provider platform 120, of a provider office device 122a-n associated with a back office of a provider 102a-n. Similar and corresponding terms used to describe system 100 in conjunction with FIG. 1 may be used to describe the functionality shown in FIG. 5. As described above, a geolocation feature may be used on a provider field device 124a to track the geolocation of a field worker (and more specifically, to track the field device 124a associated with the field worker) who has been assigned to complete a particular task. The geolocation feature is a critical feature in the construction industry because builders and providers are typically unable to confirm whether a field worker has arrived on site, has begun work, how much work has been completed, and/or has completed work without physically entering the construction site. As described above, a builder 101 may use this feature to ensure that a given provider has commenced/completed the assigned task at hand, without the builder 101 having to drive to the construction site to see whether a task has commenced or has been completed. Providers 102a-n may also use the geolocation feature to track their field workers, including, e.g., their transit route and time to the assigned construction site, their arrival at the construction site, when they leave the construction site, and their total time spent at the construction site. This time tracking feature may be used by providers 102a-n to determine metrics, analytics, and other data associated with field workers.

As shown in FIG. 5, for a given task 510 (which may correspond to a Work Order), the system 100 may use the geolocation feature on the provider field device 124a-n of a field worker to display, on the provider office device 122a-n, information relating to the field worker's transit time 520 (e.g., the start time, the end time, and total time spent in transit), as well as information relating to the field worker's time spent on the task 530 (e.g., start time, the end time, and total time spent on the task). This information may be used by the system 100 to determine total billable time and/or total time 540 spent on the job by the field worker. The data generated from the time tracking feature may be used by the system to generate productivity reports, analytics, and other metrics relating to a particular field worker or a plurality of field workers on one or more construction projects.

In accordance with certain embodiments, the provider platform 120 may provide additional functionality for use by providers 102a-n. In an embodiment, the provider platform 120 may provide a parts catalogue. For a given task or work order, the parts catalogue may including a listing of all parts required and/or recommended for the given task. The parts catalogue may also include a listing of available inventory, used inventory, and the like. The provider may add parts, view details relating to each part, export the parts catalogue, etc. In another embodiment, the provider platform 120 may compile information regarding the customers of a provider 102a-n. Customers of a provider may be one or more builders in the residential or commercial construction industry. The provider platform 120 may provide a list view and/or a map view of these customers based on various filters such as address, geographical territory, customer contact, etc. The provider platform 120 may also compile information relating to the field workers assigned to a particular customer, a construction project, etc.

In another embodiment, the provider platform 120a may provide paperless forms which may be configured for numerous requirements, including on the field. For example, forms may include built-in logic to handle various issues on the field. For example, forms may be set up per provider 102a-n and/or per customer. Using geolocation features (as described above), built-in logic may indicate situations such as, customer not present, invalid address, sales returns, and the like. In other embodiments, additional information can be captured by the provider and incorporated into forms. For example, the provider platform may enable functionality for bar code scanner for delivery of products such as appliances, capturing of images, etc. Each provider may customize its platform based on the business and needs of the provider.

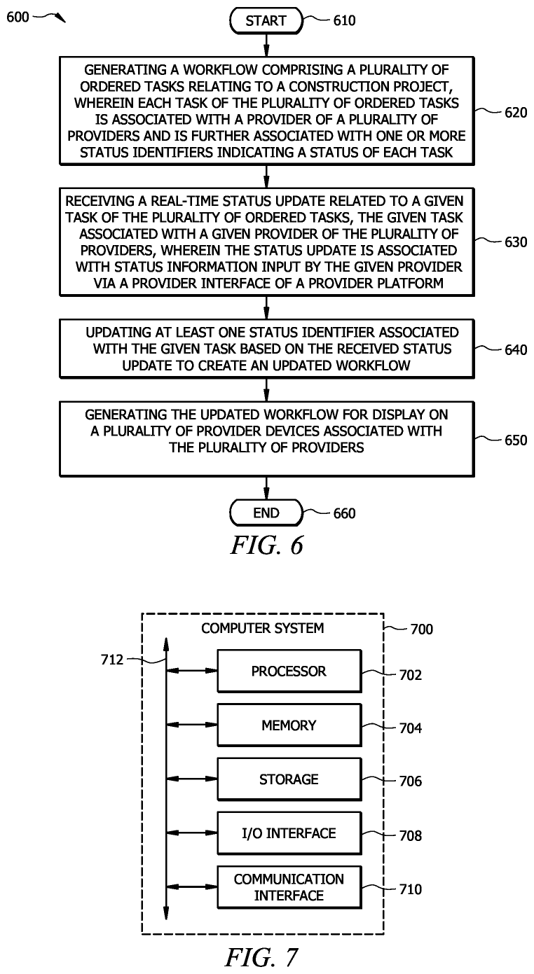

Reference is now made to FIG. 6, wherein is shown a method 600 for improved management of the supply chain of a construction project. In an embodiment, a construction project may refer to the building of a residential home. The steps of the method 600 may be in accord with the operation of system 100 shown and described in conjunction with FIG. 1, the workflow 200 shown and described in conjunction with FIG. 2, and the display screens shown and described in conjunction with FIGS. 3-5. As such, similar and corresponding terms described in conjunction with FIGS. 1-5 may have the same meaning when used in conjunction with the method 600 of FIG. 6. Additionally, the descriptions above associated with FIGS. 1-5 are hereby incorporated by reference in conjunction with method 600. Finally, although the concepts described in conjunction with method 600 may be performed from the perspective of a builder platform, a provider platform, or other element described in accordance with the present disclosure, for purposes of illustration, method 600 is herein described from the perspective of a provider platform.

The method may begin at step 610. At step 620, the provider platform may generate a workflow comprising a plurality of ordered tasks relating to a construction project. The plurality of ordered tasks may be automatically generated based on a plurality of task codes. In an embodiment, the plurality of task codes may be provided by a builder based on the type of construction project. In another embodiment, the plurality of task codes may be auto-generated by the system described in FIG. 1 based on, for example, the type of home associated with the construction project. An integration module may correlate each task code provided by the builder (or auto-generated by the system) with a corresponding task listed in a master task template stored in a system database. As described above, this correlation process may allow for the generation of the plurality of ordered tasks which make up the workflow.

Each task of the plurality of ordered tasks may be associated with a provider of a plurality of providers. In an embodiment, a provider may comprise a supplier, a contractor, a sub-contractor, a manufacturer, a wholesaler, a distributor, a labor trade, and/or any other entity in the supply chain of a construction project. Thus, a workflow having a plurality of ordered tasks may be associated with a plurality of different providers. In an embodiment, the workflow may be displayed on a provider office device and/or a provider field device through a provider interface via the provider platform. In another embodiment, the workflow may further be displayed on a plurality of provider office devices and/or a plurality of provider field devices through a plurality of provider interfaces via the provider platform. It is to be understood that the workflow may also be displayed on a builder office device and/or a builder field device through a builder interface via a builder platform.

Each task of the plurality of ordered tasks may further be associated with one or more status identifiers indicating a status of the task. In an embodiment, the one or more status identifiers may comprise information relating to one or more of a lead date of the task (the date by which an associated provider should be contacted in preparation for the task), a start date of the task (the date the associated provider is scheduled to start the task), a completion date of the task (the date the associated provider is scheduled to complete the task), whether the provider associated with the task has arrived on-site (whether geolocation data indicates the provider or a field worker associated with the provider is on the construction site to perform the task), a start time of the task on a given day (the time the provider or a field worker associated with the provider began work on a given day), a completion time of the task (the time the provider or a field worker associated with the provider ended/completed performance of the task), and a daily log image associated with the task (an image captured by the provider or a field worker of the provider in relation to the task). In an embodiment, the one or more status identifiers may be updated based on status information input by a back office employee of a provider or a field worker of a provider via a provider office device or a provider field device, respectively, through a provider interface of the provider platform. In an embodiment, the one or more status identifiers may be associated with a geolocation feature available on a field device.

At step 630, the provider platform may receive a real-time status update relating to a given task of the plurality of ordered tasks. The given task may be associated with a given provider of the plurality of providers. The real-time status update may be input by the given provider through a provider interface (i.e., a provider interface associated with the given provider) into the provider platform. The given provider may include a field worker of the provider and/or a back office employee of the provider. The real-time status update may relate to the one or more status identifiers associated with the given task. In an embodiment, the real-time status update may include information associated with the given task as it relates to the work of a field worker of the given provider. For example, the real-time status update may indicate that the field worker has started performance of the given task at the construction site. In another example, the real-time status update may indicate that the field worker has completed performance of the given task at the construction site. In another embodiment, the real-time status update may be associated with a geolocation of the field worker, and may indicate that the field worker has arrived on a construction site associated with the construction project to perform the given task. In another embodiment, the geolocation of the field worker may be used to track metrics associated with the field worker, including, e.g., when he is in transit to the assigned construction site, when he has arrived at the construction site, when he leaves the construction site, and the total time spent at the construction site. In yet another embodiment, the real-time status update may comprise a captured image relating to the given task at the construction site.

In an embodiment, a real-time status update may trigger an automatic notification or alert to inform or alert the other providers that the given task is complete. In an embodiment, the real-time status update may further trigger an alert to a second/next given provider, e.g., the provider whose assigned task is next in the workflow (e.g., the next given task), that the next given task assigned to that next given provider is due or impending performance.

At step 640, the provider platform may update at least one status identifier associated with the first given task in the workflow based on the real-time status update received, thereby resulting in an updated workflow.

At step 650, the provider platform may generate the updated workflow having at least one updated status identifier associated with the first given task for displaying on a plurality of provider devices. An updated workflow may also be generated for display on a builder device by the builder platform. In an embodiment, real-time status updates may be received from the plurality of providers in conjunction with the plurality of ordered tasks. As such, the method 600 may allow a builder and the plurality of providers to receive real-time updates and collectively manage the construction project. The method may end at step 660.

In an embodiment, an automated dispatching functionality may be provided by the provider platform, wherein a field worker of a provider may be automatically assigned to complete a task at a construction site for a construction project based on one or more parameters relating to the field worker, the task, and/or the construction project. Parameters may include the proximity of the field worker to a construction site, the availability of the field worker on the desired day/time the task is to be completed at the construction site, the training, certification, credentials, or skillset of the field worker as it pertains to the task to be completed at the construction site, the requirements associated with the task and/or construction project, and/or any other parameters known or considered in the art. As described above, the provider platform may be operable to perform various other functionalities, and include additional coordination and management tools, all of which may be incorporated into method 600.

In sum, the systems and methods of the present disclosure may allow for the integration and coordination of the entire supply chain of a residential construction project. The system allows for the collective input and transmission of data across builder and provider platforms, so that builders and providers (suppliers, contractors, distributors, wholesalers, manufacturers, and customers) may collaboratively perform tasks, maintain current information, and manage the status of the project from start to finish. At the same time, each builder and provider may use its respective platform to manage its own business, including its employees, inventory, etc.

Although the present disclosure describes the integration and coordination of information between different entities in a residential construction context (builder and providers, including suppliers, manufacturers, etc.), it is to be understood that the present disclosure may be extended to other contexts, businesses, and enterprises, including outside of the field of construction. The systems, methods, and principles described herein may also be used for the integration and coordination of information within a single entity (i.e., between different divisions within a company, etc.)

Reference is now made to FIG. 7, wherein is shown an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein. Embodiments according to the disclosure are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

What is claimed is:

1. A system, comprising:
one or more processors; and
one or more computer-readable non-transitory storage media comprising instructions that, when executed by the one or more processors, cause one or more components of the system to perform operations comprising:
generating a workflow comprising a plurality of ordered tasks relating to a construction project associated with a construction site, wherein each task of the plurality of ordered tasks is associated with a provider of a plurality of providers and is further associated with one or more status identifiers indicating a status of each task;
receiving a real-time status update related to a given task of the plurality of ordered tasks, the given task associated with a given provider of the plurality of providers, wherein the real-time status update is associated with status information input by the given provider via a provider interface of a provider platform;
updating at least one status identifier associated with the given task based on the received real-time status update to create an updated workflow; and
generating the updated workflow for display on a plurality of provider devices associated with the plurality of providers.

2. The system of claim 1, wherein the workflow is generated based on a plurality of task codes.

3. The system of claim 1, wherein the received real-time status update comprises information associated with a field worker of the given provider.

4. The system of claim 3, wherein the received real-time status update is associated with a geolocation of the field worker, and indicates that the field worker has arrived on the construction site to perform the given task.

5. The system of claim 3, wherein the received real-time status update indicates that the field worker has completed performance of the given task at the construction site.

6. The system of claim 1, wherein the real-time status update automatically triggers an alert to a next given provider associated with a next given task of the plurality of ordered tasks that the next given task is impending performance.

7. The system of claim 1, the operations further comprising:
automatically assigning a field worker of the given provider to perform the given task based on parameters relating to at least one of the field worker, the given task, or the construction project.

8. A method, comprising:
generating a workflow comprising a plurality of ordered tasks relating to a construction project associated with a construction site, wherein each task of the plurality of ordered tasks is associated with a provider of a plurality of providers and is further associated with one or more status identifiers indicating a status of each task;
receiving a real-time status update related to a given task of the plurality of ordered tasks, the given task associated with a given provider of the plurality of providers, wherein the real-time status update is associated with status information input by the given provider via a provider interface of a provider platform;
updating at least one status identifier associated with the given task based on the received real-time status update to create an updated workflow; and
generating the updated workflow for display on a plurality of provider devices associated with the plurality of providers.

9. The method of claim 8, wherein the workflow is generated based on a plurality of task codes.

10. The method of claim 8, wherein the received real-time status update comprises information associated with a field worker of the given provider.

11. The method of claim 10, wherein the received real-time status update is associated with a geolocation of the field worker, and indicates that the field worker has arrived on the construction site to perform the given task.

12. The method of claim 10, wherein the received real-time status update indicates that the field worker has completed performance of the given task at the construction site.

13. The method of claim 8, wherein the real-time status update automatically triggers an alert to a next given provider associated with a next given task of the plurality of ordered tasks that the next given task is impending performance.

14. The method of claim 8, further comprising:
automatically assigning a field worker of the given provider to perform the given task based on parameters relating to at least one of the field worker, the given task, or the construction project.

15. One or more computer-readable non-transitory storage media embodying instructions that, when executed by a processor, cause performance of operations comprising:
generating a workflow comprising a plurality of ordered tasks relating to a construction project associated with a construction site, wherein each task of the plurality of ordered tasks is associated with a provider of a plurality of providers and is further associated with one or more status identifiers indicating a status of each task;
receiving a real-time status update related to a given task of the plurality of ordered tasks, the given task associated with a given provider of the plurality of providers, wherein the real-time status update is associated with status information input by the given provider via a provider interface of a provider platform;
updating at least one status identifier associated with the given task based on the received real-time status update to create an updated workflow; and
generating the updated workflow for display on a plurality of provider devices associated with the plurality of providers.

16. The one or more computer-readable non-transitory storage media of claim 15, wherein the received real-time status update comprises information associated with a field worker of the given provider.

17. The one or more computer-readable non-transitory storage media of claim 16, wherein the received real-time status update is associated with a geolocation of the field worker, and indicates that the field worker has arrived on the construction site to perform the given task.

18. The one or more computer-readable non-transitory storage media of claim 16, wherein the received real-time status update indicates that the field worker has completed performance of the given task at the construction site.

19. The one or more computer-readable non-transitory storage media of claim 15, wherein the real-time status update automatically triggers an alert to a next given provider associated with a next given task of the plurality of ordered tasks that the next given task is impending performance.

20. The one or more computer-readable non-transitory storage media of claim 15, the operations further comprising:
automatically assigning a field worker of the given provider to perform the given task based on parameters relating to at least one of the field worker, the given task, or the construction project.
